(19) United States
(12) Patent Application Publication
(10) Pub. No.: US 2007/0170770 A1
(43) Pub. Date: Jul. 26, 2007

(54) Vehicle seat with seat-integrated shoulder safety belt

(76) Inventor: Meinhard Behrens, Obernkirchen (DE)

Correspondence Address: SHILESINGER, ARKWRIGHT & GARVEY LLP, Suite 600, 1420 King Street, Alexandria, VA, 22314, US

(21) Appl. No.: 11/657,589

(22) Filed: Jan. 25, 2007

(30) Foreign Application Priority Data
Jan. 26, 2006 (DE) 10 2006 003 652.2

(51) Int. Cl. B60R 22/00

(52) U.S. Cl. 297/476

(57) ABSTRACT

Vehicle seat includes a seat section with a seat section frame and a backrest with a backrest frame, which is connected to seat section by inclination adjustment fittings such that it is pivotable around a backrest pivoting axis. Vehicle seat includes a seat-integrated safety belt with a shoulder belt outlet provided in upper backrest area and with backrest/adjustment fitting overload protection. The backrest/adjustment fitting overload protection includes a shoulder belt deflection element provided in shoulder belt outlet, is fixed in the backrest frame, is capable of shifting against a level of prestress, and a locking device. Locking device is actively connected to deflection element via a coupler, which conducts dynamic load or force exerted by a passenger via shoulder belt onto deflection element during a front crash into seat section frame via locking device.

### CROSS-REFERENCE TO RELATED APPLICATIONS

This application claims the priority of German application no. 10 2006 003 652.2, filed 26, Jan. 2006, and which is incorporated herein by reference.

### FIELD OF THE INVENTION

The invention relates to a vehicle seat with a seat-integrated shoulder safety belt. More particularly, the invention relates to a vehicle seat which includes a seat section with a seat section frame and a backrest with a backrest frame, which is connected to seat section by inclination adjustment fittings such that it is pivotable around a backrest pivoting axis, and the vehicle seat including a seat-integrated safety belt with a shoulder belt outlet provided in the upper backrest area and with backrest/adjustment fitting overload protection.

### BACKGROUND OF THE INVENTION

In vehicle seats having seat-integrated shoulder belts, the shoulder belt is fastened to the seat rather than to the B-pillar. During a front crash, substantial forces are transferred by the seated passenger through the shoulder belt to the backrest and the backrest inclination adjustment fittings, potentially causing damage to the adjustment mechanism.

From DE 10 2004 004 402 B3, a vehicle seat including a seat frame that can be adjusted in terms of height and/or inclination in relation to a chassis of a vehicle using an adjustment mechanism, and a safety belt attachment which is arranged on the seat frame is known. Forces that act upon the safety belt attachment during normal operation of the vehicle seat are transferred via the adjustment mechanism into the chassis. During a crash, forces that act upon the safety belt attachment circumvent the adjustment mechanism and are transferred via a force transmitting device into the chassis. The force transmitting device includes a four-bar linkage, whereby a first link is assigned to the seat frame, an opposite, second link is assigned to the safety belt attachment, and the links positioned between the first and second links are assigned to latching means, respectively. During normal operation of the vehicle, the first and second links are held spaced from one another by a connecting means, which can be extended in the event of a crash to allow the latching means to become engaged in an opposite area that is positioned on the chassis.

From DE 296 23 024 U1 a supplementary safety mechanism for locking the backrest of a vehicle seat in a preset inclination position based upon an accelerating motion acting in the longitudinal direction of the vehicle is known, whereby the backrest of the vehicle seat is attached in the seat section such that it is capable of pivoting around a horizontal axis, and the backrest includes an arc-shaped toothed segment on at least one side. A latch that is mounted so as to allow it to pivot around a horizontal axis is arranged on the backrest, and includes a latch area that is configured so as to allow form-fitting engagement with the toothed segment and lies out of engagement when the vehicle is in a non-accelerated state and, when a predetermined acceleration level is exceeded, lies engaged with the toothed segments. A double-armed lever constructed as a centrifugal mass is provided, which is mounted so as to pivot around the center point on the arc of the arc-shaped toothed segment, through which the horizontal axis extends. The lever arms of the lever have different masses, whereby the lever arm having the smaller mass is pivotably attached to the latch, and a spring holds the latch out of engagement with the toothed segment in a non-accelerated state.

### OBJECTS AND SUGARY OF THE INVENTION

An object of the present invention is to construct a vehicle seat of the type described at the outset, such that an optimized backrest/adjustment fitting overload protection during a front crash is achieved.

This object, and others, is achieved by the inventive vehicle seat which includes a seat section with a seat section frame and a backrest with a backrest frame, which is connected to the seat section by inclination adjustment fittings such that it is pivotable around a backrest pivoting axis. The vehicle seat includes a seat-integrated safety belt with a shoulder belt outlet provided in an upper backrest area and with backrest/adjustment fitting overload protection. The backrest/adjustment fitting overload protection includes a shoulder belt deflection element provided in a shoulder belt outlet, is fixed in the backrest frame, is capable of shifting against a level of prestress, and a locking device. The locking device is actively connected to the deflection element via a coupler, which conducts dynamic load or force exerted by a passenger via the shoulder belt onto the deflection element during a front crash and into the seat section frame via the locking device.

Another object of the present invention is to overcome the drawbacks of the prior art.

The invention includes that the shoulder belt outlet be spring-mounted in the backrest. During a front crash, beyond a specific load level, the spring yields and the belt deflection mechanism is shifted against the force of the spring by the centrifugal force created by the front crash, in the direction of the centrifugal force. In this manner, the centrifugal force created by the front crash is directed via a coupling mechanism through a locking mechanism from the backrest into the seat frame, circumventing the inclination adjustment fittings.

The invention further includes that the vehicle seat includes a seat section, the seat section including a seat section frame and a backrest with a backrest frame, which is connected via inclination adjustment fittings to the seat section such that it can pivot around a backrest pivoting axis. There is a seat-integrated shoulder safety belt with a shoulder belt outlet provided in an upper backrest area. Backrest/adjustment fitting overload protection is provided. The backrest/adjustment fitting overload protection includes a shoulder belt deflection element provided in the shoulder belt outlet stationarily affixed to the backrest frame, and mounted such that it can shift in the backrest frame against a prestress. There is a locking device, actively connected to the deflection element via a coupler, which coupler is actively connected to the seat section frame, and which during a front crash, in use, conducts the dynamic load or force that is exerted by a passenger via the shoulder belt onto the deflection element into the seat section frame via the locking device.

Advantageous and expedient further improvements in accordance with the invention are set forth below.

Below, the invention will be described in greater detail with reference to the attached set of drawings, in which an exemplary embodiment is illustrated.

### BRIEF DESCRIPTION OF THE DRAWINGS

FIG. 1 is a schematic side view of a vehicle seat with its passenger wearing a seat-integrated shoulder belt, in the use position; and

FIG. 2 is a schematic side view of the inventive vehicle seat of FIG. 1, with the passenger, during a frontal crash.

### DETAILED DESCRIPTION OF THE INVENTION

In the figures, equivalent and corresponding components are assigned the same reference numerals.

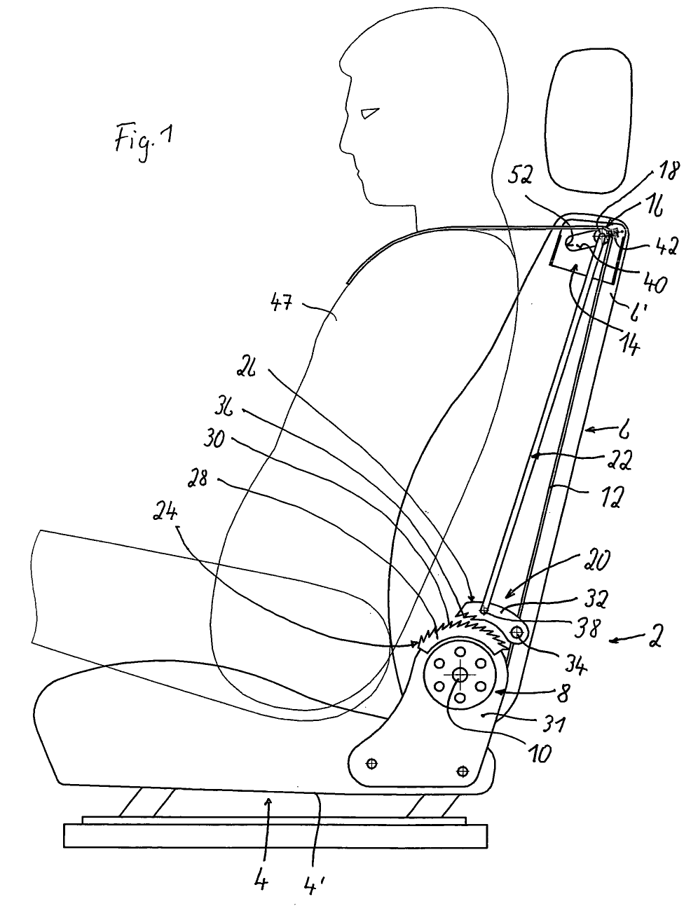

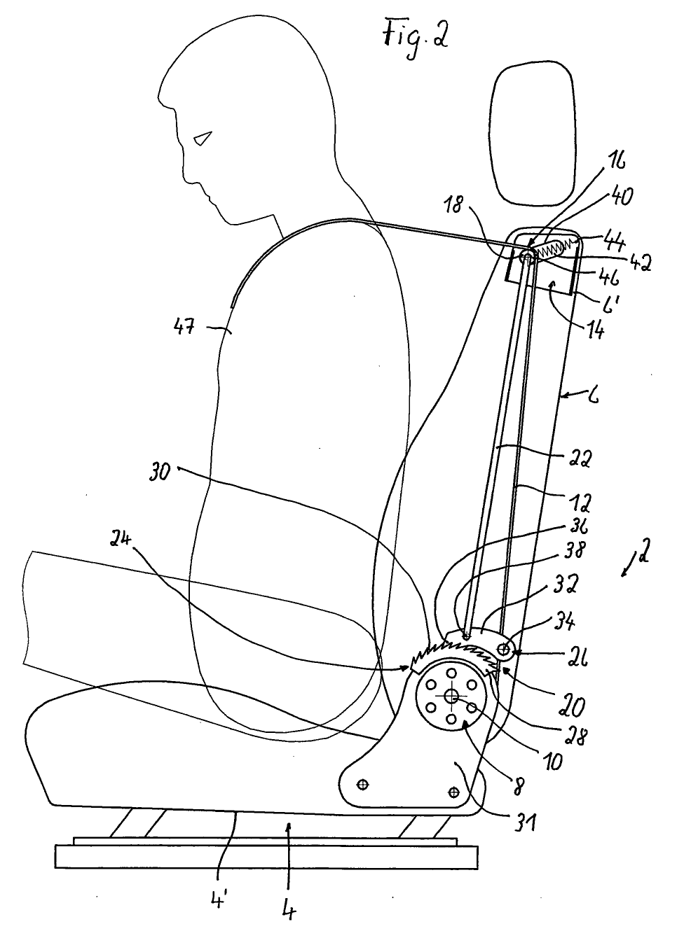

FIGS. 1 and 2 show a vehicle seat 2 including a seat section 4 with a seat section frame 4′ and a backrest 6 with a backrest frame 6′, which is attached to the seat section 4 via inclination adjustment fittings 8 such that it is pivotable around a backrest pivoting axis 10.

The vehicle seat 2 is equipped with a seat-integrated shoulder belt 12. In the upper backrest area a shoulder belt outlet 14 with a belt deflection mechanism 16 is constructed.

To prevent an overload to the adjustment fittings 8, a backrest/adjustment fitting overload protection is provided, which includes a shoulder belt deflection element 18 that is positioned in the shoulder belt outlet 14 and is movably mounted in the backrest frame 6′, and a locking device 20, which is actively connected to the deflection element 18 via a coupler 22. The coupler 22 can be a connecting rod, as shown. The deflection element 18 can be, for example, a pivot bolt, a roller, or a similar device.

The locking device 20 includes a first locking means 24 that is stationarily affixed to the seat frame and a second locking means 26 that is stationarily affixed to the backrest frame and is connected to the coupler 22.

The first locking means 24 includes an arc-shaped toothed segment 28, whereby the center point on the arc of the arc-shaped toothed segment 28 coincides with the backrest pivoting axis 10. The toothed segment 28 is equipped with external toothing 30 and is positioned above the adjustment fitting 8 on an adapter 31 that is stationarily affixed to the seat section. The second locking means 26 includes a latch 32, which is mounted such that it can rotate around an axis 34 that is stationary on the backrest frame. The latch includes at least one latch tooth 36 which is provided for engagement with the external toothing 30 of the toothed segment 28.

The coupler or the connecting rod 22 is pivotably connected, along with the deflection element 18, to the latch 32 at a pivoting point 38 that is spaced from the axis 34 of the latch 32.

The deflection element 18 is guided in a pivoted link 40 constructed in the backrest frame 6′. The deflection element 18 is prestressed in the direction of release of the locking device 20 by means of a helical tension spring 42, one end 44 of which is connected to the backrest 6 while the other end 46 is connected to the deflection element 18, cf. FIG. 2.

In the position of use illustrated in FIG. 1, the deflection element 18 rests at the back end of the pivoted link 40 by virtue of the force of the helical tension spring 42.

During a front crash, a passenger 47 is accelerated forward, as is shown in FIG. 2. The forces of acceleration or centrifugal forces cause the shoulder belt 12 to move the deflection element 18 forward in the pivoted link 40 against the prestressing of the helical tension spring 42, up to a front stop 52 that is fixed to the backrest and is formed by the front end of the pivoted link 40 when viewed in the direction of travel. With this, the deflection element 18 exerts pressure on the coupler 22, which pivots the latch 32 downward, counterclockwise in the drawing. This causes the latch teeth 36 to engage with the external toothing 30 of the toothed segment 28. Circumventing the adjustment fittings 8, the load that is created during a front crash is thus conducted via the backrest/adjustment fitting overload protection specified in the invention directly from the backrest frame 6′ into the seat section frame 4′. An overload of the inclination adjustment fittings 8 is thereby prevented.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Vehicle seat, comprising:
a) a seat section;
b) the seat section including a seat section frame and a backrest with a backrest frame, which is connected via inclination adjustment fittings to the seat section such that it can pivot around a backrest pivoting axis;
c) a seat-integrated shoulder safety belt with a shoulder belt outlet provided in an upper backrest area;
d) a backrest/adjustment fitting overload protection being provided;
e) the backrest/adjustment fitting overload protection including a shoulder belt deflection element provided in the shoulder belt outlet stationarily affixed to the backrest frame, and mounted such that it can shift in the backrest frame against a prestress; and
f) a locking device, actively connected to the deflection element via a coupler, which coupler is actively connected to the seat section frame, and which during a front crash, in use, conducts the dynamic load or force that is exerted by a passenger via the shoulder belt onto the deflection element into the seat section frame via the locking device.

2. Vehicle seat according to claim 1, wherein:
a) the deflection element is guided in a pivoted link/slot provided in the backrest frame.

3. Vehicle seat according to claim 1, wherein:
a) the deflection element is prestressed in the direction of release of the locking device.

4. Vehicle seat according to claim 3, wherein:
a) the prestressing of the deflection element is generated by a helical tension spring, one end of which is connected to the backrest frame, while the other end is connected to the deflection element.

5. Vehicle seat according to claim 1, wherein:
a) the locking device includes a first locking device stationarily affixed to the seat section frame;
b) and a second locking device connected to the coupler, is stationarily affixed to the backrest frame, and can be locked and released with the first locking device.

6. Vehicle seat according to claim 5, wherein:
a) the first locking device stationarily affixed to the seat section includes an arc-shaped toothed segment with external toothing; and
b) the second locking device includes a latch that is mounted so as to pivot around an axis fixed in the backrest frame; and
c) the latch includes at least one latch tooth that is provided for engagement with the external toothing of the toothed segment.

7. Vehicle seat according to claim 6, wherein:
a) the toothed segment is provided above the adjustment fitting on an adapter that is stationarily affixed to the seat frame.

8. Vehicle seat according to claim 6, wherein:
a) a center point on the arc of the arc-shaped toothed segment coincides with the backrest pivoting axis.

9. Vehicle seat according to claim 6, wherein:
a) the coupler is pivotably connected to the deflection element, and is pivotably connected to the latch in a pivoting point that is spaced from the axis of the latch.

10. Vehicle seat according claim 1, wherein:
a) the coupler is formed by a connecting rod.

11. Vehicle seat according to claim 6, wherein:
a) the toothing is configured as saw toothing.
